(19) United States
(12) Patent Application Publication
(10) Pub. No.: US 2024/0189872 A1
(43) Pub. Date: Jun. 13, 2024

(54) ANNULAR NOZZLE

(71) Applicant: BAUSCH + STROBEL SE + CO.KG, Ilshofen (DE)

(72) Inventors: Heiko Schwarz, Feuchtwangen (DE); Werner Ilander, Schwabisch Hall (DE); Jonas Lechler, Crailsheim (DE)

(73) Assignee: BAUSCH + STROBEL SE + CO.KG, Ilshofen (DE)

(21) Appl. No.: 18/551,928

(22) PCT Filed: Mar. 18, 2022
(86) PCT No.: PCT/EP2022/057204

§ 371 Date: Sep. 22, 2023

(30) Foreign Application Priority Data
Mar. 23, 2021 (DE) 10 2021 107 234.4

(51) Int. Cl. B08B 9/28; B08B 9/32; B08B 9/34; B08B 9/42

(52) U.S. Cl. CPC B08B 9/283; B08B 9/32; B08B 9/34; B08B 9/426

(57) ABSTRACT

A cleaning apparatus for pharmaceutical containers, comprising means for feeding containers into and means for discharging containers from the cleaning apparatus, a transport apparatus for transporting containers within the cleaning apparatus, at least one holder for holding containers during a cleaning process, and one or more cleaning stations. Each holder holds a container such that a longitudinal axis of the container extends substantially in a vertical direction. Each cleaning station comprises at least one substantially cylindrically formed annular nozzle configured to completely surround a container during the cleaning process. Each cleaning station is provided on its inner side with a first row of outlet openings disposed circumferentially in a first vertical position, and is configured to discharge a cleaning medium substantially identically inwardly and downwardly at an angle to a horizontal axis and at an angle to a radial direction to form a cyclone of cleaning medium.

The present invention relates to a cleaning apparatus for pharmaceutical containers, comprising means for feeding the containers into the cleaning apparatus and means for discharging the containers from the cleaning apparatus, a transport apparatus for transporting the pharmaceutical containers within the cleaning apparatus, and at least one holder for holding at least one pharmaceutical container during a cleaning process such that the longitudinal axis of each of the pharmaceutical containers extends substantially in a vertical direction.

It is known from the prior art to use water jets to clean off powdery substances adhering to pharmaceutical containers using external cleaning systems. However, due to the low adhesion of such contaminants, only low water pressures are used for this purpose, so that the water jets have a low mechanical cleaning effect. It is further known, when cleaning the outer surfaces of pharmaceutical containers which are contaminated by upstream processes, to use cleaning brushes for the mechanical removal of strongly adhering substances. However, such a process may be unfavourable in the case of toxic products and, in any case, requires considerable cleaning effort.

Although systems are also known for similar applications in which high water pressures are used, problems arise with the sealing of points on pharmaceutical containers that must not come into contact with water during such processes, as there is a risk of contamination of the product by the cleaning medium if the closure is penetrated, for example through a remaining gap. There is also a risk of micro-organisms growing on and under the closure if moisture has penetrated. Finally, as a general principle, metallic closures or other areas at risk of corrosion should always be protected from spray water, so that, in view of the increased water pressures when using commonly available nozzles, a large amount of generated spray water has to be controlled at considerable effort.

No cleaning apparatus is known for pharmaceutical containers that enables efficient and economical cleaning of the outer surfaces of containers with little spray directed towards a sealing area. Providing such a cleaning apparatus would greatly reduce the sealing problems that occur compared to previously known systems and would significantly improve the failure rate of such systems, as the corresponding sealing points would be subjected to considerably less stress.

Consequently, it is the task of the present invention to provide a cleaning apparatus for pharmaceutical containers of the above-mentioned type, by means of which strongly adhering substances on the outer surfaces of, for example, sealed containers of this type can be cleaned off, the occurrence of spray water being minimised as far as possible in order to subject the sealing points of the containers to as little stress and corrosion as possible.

To solve this task, the cleaning apparatus according to the invention comprises at least one cleaning station for cleaning pharmaceutical containers, comprising at least one substantially cylindrically formed annular nozzle which is configured to completely surround one of the pharmaceutical containers during a cleaning process and is provided on its inner side with a row of outlet openings disposed circumferentially in a first vertical position, each of which is configured and adapted to discharge a cleaning medium substantially identically inwardly and downwardly at an angle to the horizontal and at an angle to a radial direction, so as to form a cyclone of cleaning medium. Here, the term “cyclone” is to be understood to mean that the cleaning medium is directed downwards in a vortex to flow around the container to be cleaned in a clockwise or counter-clockwise direction.

The generation of such a cyclone minimises the occurrence of spray water, particularly in the vertically upward direction, as an optimised flow of cleaning medium downwards and along the circumference of the container is achieved. Here, the orientation of the outlet openings acting as nozzles can in particular be such that the angle relative to the radial direction is adjusted depending on the shape and circumference of the pharmaceutical containers, so that the resulting jet of cleaning medium meets the surface of the corresponding container in a substantially tangential direction, thereby further helping to minimise spray. The cleaning performance to be achieved is also optimised by the special arrangement and orientation of the outlet openings and the jets of cleaning medium thereby generated, so that in many scenarios the effect of mechanical brushes can be achieved or even surpassed. Furthermore, due to the greater cleaning efficiency of the described annular nozzle, the necessary amount of cleaning medium can be reduced compared to the external cleaning systems mentioned above, thereby increasing the economic efficiency of the cleaning apparatus as a whole.

Although the annular nozzle described above with only one row of outlet openings already solves the underlying task of the present invention, in an advantageous further development the annular nozzle may further comprise a second row of outlet openings at a second vertical position lying above the first position, the outlet openings of the second row also being configured and adapted to discharge a cleaning medium in each case substantially identically inwardly and downwardly at an angle to the horizontal and at an angle to a radial direction so as to form a cyclone in the manner described above, the angle to the horizontal being preferably greater for the second row of outlet openings than for the first row of outlet openings and/or being preferably, for example, 30°.

Realising the annular nozzle as a double annular nozzle means, on the one hand, that a strong mechanical cleaning effect can be generated by the ring of jets of cleaning medium of the first row of outlet openings arriving at the object surface at a more obtuse angle with an optimal angular orientation relative to the radial direction in the manner described above, while on the other hand spray development is minimised, especially in the upward direction, since the outflowing cleaning medium is directed more strongly downwards by the second ring of jets forming a cyclone with a steeper angular orientation. Consequently, the cleaning effect of the process on the outer surfaces of the pharmaceutical containers is improved, while upward spray is reduced to a minimum.

At the same time, this means that the necessary pressure of the cleaning medium can be reduced by supplementing the cleaning medium from the first row of outlet openings meeting the container to be cleaned at a flat angle by providing additional cleaning medium via the second ring of jets favouring the discharge direction for an optimal cleaning effect. This produces a synergetic effect in that the combination of jet rings of the two rows of outlet openings according to the invention does not require any additional cleaning medium, since the medium from the second row of outlet openings which shields against upward spray is also used directly for cleaning, and the consumption of cleaning medium by the first row of outlet openings can be controlled in this way.

A further measure for reducing spray in the further embodiment of the present invention just described can be achieved by the outlet openings of the first row and the outlet openings of the second row each being configured to discharge the cleaning medium at an angle to the same side with respect to the radial direction, so as to form cyclones running in the same direction which, by the nature of their interaction with one another, have less of a tendency to form spray.

Although such annular nozzles can of course be installed and operated individually, an option is to provide at least one pair of annular nozzles which are supported in a substantially symmetrical manner on a common holder, a supply channel for delivering cleaning medium to the two annular nozzles being provided within the holder.

Here, in order to supply the at least one row of outlet openings, an annular channel for transport of cleaning medium can be provided in each case, running around the annular nozzle, through which the outlet openings are each supplied, the transition between the supply channel and each of the annular channels being realised via a connection, for example a blind hole, and bores running obliquely to the direction in which the holder extends.

This measure ensures that the flow of cleaning medium towards the outlet openings is optimised and as laminar as possible, thereby reducing turbulence losses and allowing the cleaning medium to be supplied at a reduced pressure. The optimised media flow also optimises the uniform and repeatable cleaning of the containers. Furthermore, the outlet openings are supplied essentially simultaneously so that they form the jets and thus the cyclone quickly and evenly.

Although, of course, the cleaning effect ultimately achieved depends, among other things, on the pressure of the ejected cleaning medium and can be chosen taking into account the nature and stubbornness of the contamination on the containers, the embodiment of the cleaning apparatus according to the invention just described also allows it to be operated at any rate in a low-pressure range, for example down to 0.5 bar. However, by guiding the cleaning medium within the corresponding feed channels and annular channels in this way, operation in a high-pressure range of up to at least 3.5 bar is also readily possible, should the nature of the contamination of the pharmaceutical containers so require.

To avoid dead spaces in the described cleaning apparatus, at least one flat seal can be provided to seal the at least one annular nozzle, which can be provided, for example, in the area of the nozzle rings and bore closures.

Furthermore, the cleaning apparatus according to the invention can include a drying station which is disposed downstream of the cleaning station with respect to the transport apparatus and preferably comprises at least one annular drying unit which is configured to completely surround one of the pharmaceutical containers during a drying process. This drying station may also be provided in the manner described above in order to generate at least one cyclone with correspondingly disposed outlet openings for a gaseous drying medium and may comprise, also in the manner described above, a paired arrangement of drying units and a corresponding supply of drying medium in a single holder.

While it is of course possible for the annular nozzle and/or the at least one annular drying unit to be disposed statically within the cleaning apparatus according to the invention and then either act only on a single portion of the pharmaceutical containers to be cleaned or for these pharmaceutical containers themselves to be displaceable relative to the annular nozzle and/or the drying unit in a vertical direction during the cleaning or drying process, in a particularly efficient and simply designed embodiment the at least one annular nozzle and/or the at least one annular drying unit can be displaceable in a vertical direction in a manner coordinated with the transport apparatus.

In this way, the container to be cleaned and/or dried is first moved by the transport apparatus to a position provided for this purpose, whereupon the annular nozzle or the annular drying unit is then moved along its vertical extension so as to allow cleaning of contamination or drying of the container over a large area. In particular, for this purpose, the annular nozzle and/or the drying unit can be moved vertically from below over the container to be cleaned or dried and held from above, while in other embodiments, however, it is also conceivable to construct the annular nozzle and/or the annular drying unit in a plurality of parts, for example by means of two half-shells, which, with the transported container in a cleaning configuration, are moved laterally towards it so as to surround it completely during the cleaning or drying process.

Since the corresponding pharmaceutical containers to be cleaned are frequently transported in such a way that their closure points vertically upwards, a solution may therefore be to configure the at least one holder for the corresponding containers as a gripper and to assign it to the transport apparatus, the gripper being adapted in this case to hold the at least one pharmaceutical container at its upper end. Here, the corresponding gripper can optionally be adapted to grip vials, ampoules and/or carpules, it being possible, in a cleaning apparatus according to the invention, to realise a quick and efficient changeover from one type of container to the other simply by replacing or modifying the corresponding grippers.

Although, in the embodiment just described, gripping of the containers in the immediate vicinity of their closure is possible, but should possibly be avoided to prevent damage or stress thereto, the at least one gripper may alternatively be adapted to grip a pharmaceutical container at a neck portion thereof with a gripping portion and for this purpose has a receiving space for receiving the head portion of the container in the gripped state, in which this head portion and, if applicable, the closure of the pharmaceutical container then lies with the container in the gripped state.

In this case, it may further be provided that the gripping portion is adapted to grip the container in a sealed manner so that the receiving space just mentioned is sealed from the environment with the container in the gripped state, with further means preferably being provided for applying a gaseous medium at an elevated pressure to the receiving space. This then provides a further safety measure which reliably prevents spray or other impurities from entering the area of the head portion of the container during a cleaning and/or drying process.

Particularly when cleaning and/or drying ampoules, it may further be advantageous to provide at least one height-displaceable support apparatus which is adapted to carry the corresponding pharmaceutical container below one of the annular nozzles or one of the annular drying units, so that the support apparatus can be used in addition to or as an alternative to the gripping portion.

Furthermore, the cleaning apparatus according to the invention may comprise a blow-off station which is disposed downstream of the cleaning station with respect to the transport apparatus and, if applicable, is disposed between the cleaning station and the drying station, the blow-off station being adapted to blow off the holders associated with the transport apparatus by means of at least one air curtain, for example by means of two air curtains disposed at an angle to each other. The provision of such a blow-off station can prevent water carry-over, particularly in embodiments of the present invention in which high media pressures are used in the cleaning station, leading to increased spray formation and wetting of the holders. In this case, the air curtain can be formed by any suitable nozzle arrangements that are supplied with compressed air.

Furthermore, according to the present invention, the cleaning apparatus may implement an empty space compensation system, wherein an empty space detection unit associated with the container feeding means is provided, which is adapted to detect that at an input position of the container feeding means there is no container but rather an empty space, and wherein furthermore the transport apparatus is adapted to hold back the next holder in the event of an empty space in a transfer area between the container feeding means and the transport apparatus until a container is again fed into the transfer area by the container feeding means. This empty space compensation system ensures that each of the holders always carries a container during operation and prevents spray water carry-over at unoccupied holders.

Furthermore, the transport apparatus can be adapted to be operable in a start-up mode, in which all of the holders are moved out of the area of the cleaning station and, if applicable, the drying station when the cleaning apparatus is started up. This can prevent undesirable operating conditions from occurring while the apparatus is being put into operation, during which time media lines must be filled with cleaning medium, which could lead to spray water carry-over.

Finally, the cleaning apparatus may be further adapted to be operable in a repeat cleaning mode, in which, in the event of a malfunction of the cleaning station and/or the drying station, containers that have already been treated in the corresponding station are re-treated. In this case, the entire intended cycle of the corresponding station can be run through again, for example including vertical displacement of the containers and all other steps, but in such a way that the transport apparatus does not carry out any further transport of the containers in the meantime. To detect such a malfunction, different types of sensors may be considered, for example sensors that directly monitor the function of the corresponding components of the apparatus in real time and can detect, for example, a drop in pressure of the cleaning medium, or sensors that visually check the cleaning result achieved on the containers and, if applicable, identify a malfunction of the corresponding station in case of an unsatisfactory cleaning result.

Other features and advantages of the present invention become clearer from the following description of embodiments thereof when considered together with the accompanying figures. These show the following:

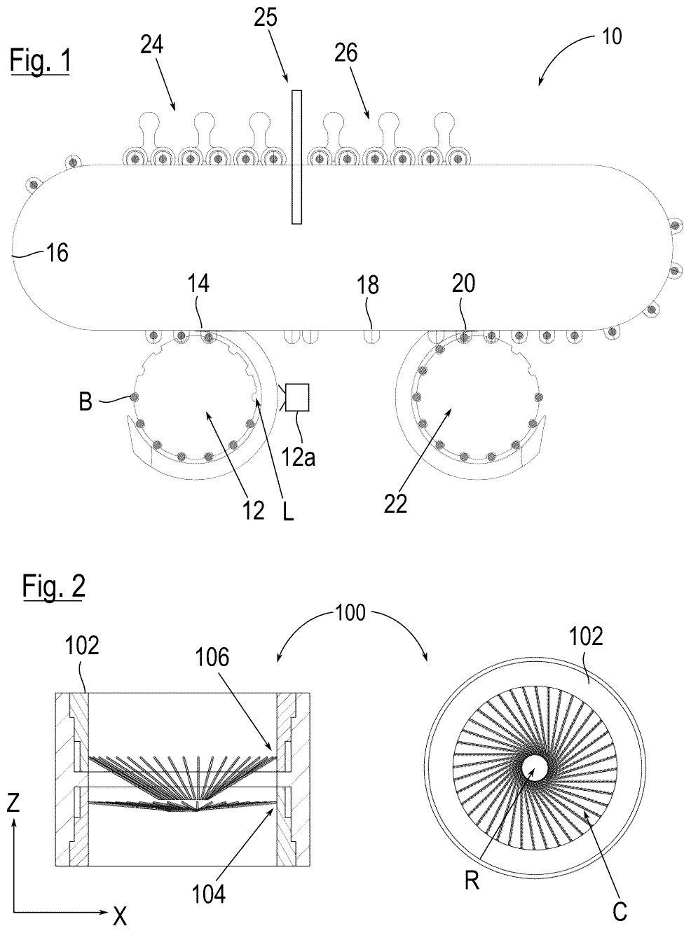

FIG. 1A general schematic plan view of a cleaning apparatus according to the invention.

FIG. 2A possible embodiment of an annular nozzle from the apparatus in FIG. 1 in two schematic views.

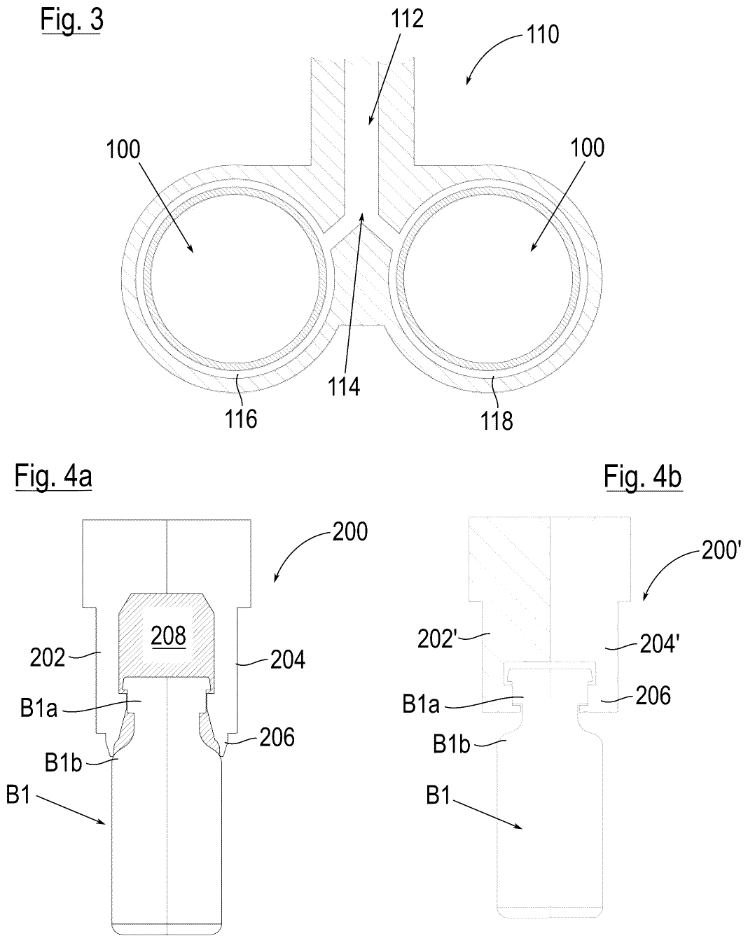

FIG. 3A pair of such annular nozzles with a common holder in a cross-sectional view.

FIGS. 4a and 4b Two variants of an embodiment of a gripper for a pharmaceutical container from the apparatus in FIG. 1 in a cross-sectional view.

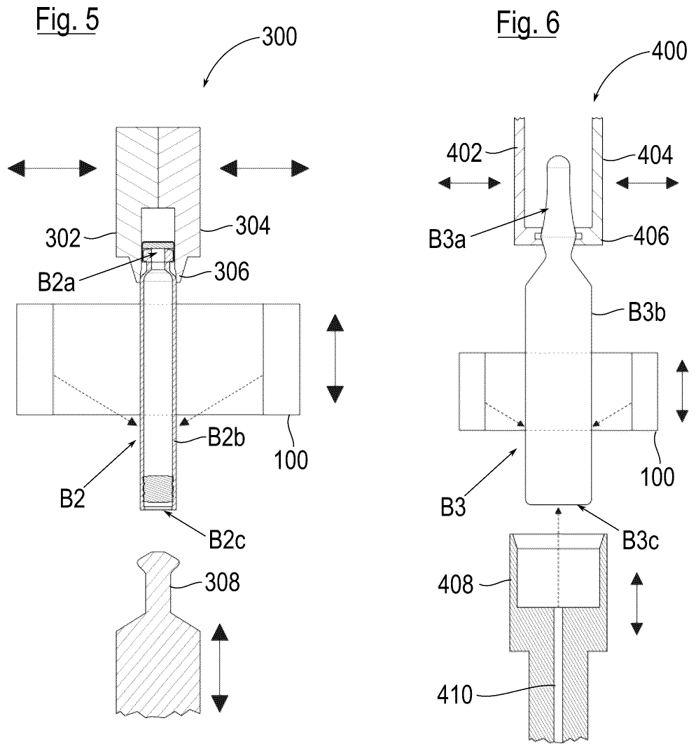

FIG. 5A variant of a gripper for use with carpules in a cross-sectional view.

FIG. 6A variant of a gripper and a support apparatus for use with ampoules in a cross-sectional view.

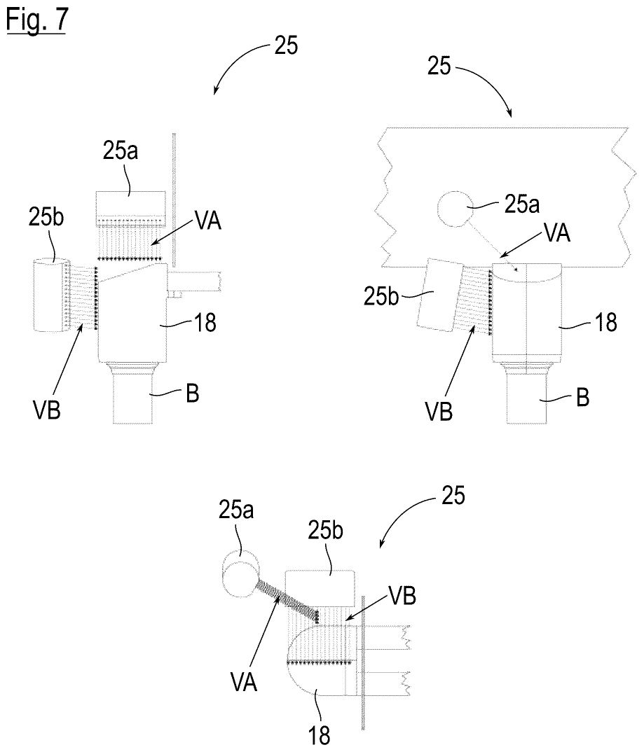

FIG. 7 An embodiment of the blow-off station from FIG. 1.

In FIG. 1, firstly, a cleaning apparatus for pharmaceutical containers according to the invention is shown in a schematic plan view and generally designated with the reference sign 10. It is understood that the entire cleaning apparatus 10 or at least parts thereof can be accommodated in suitable enclosures for this purpose, for example clean room stages, with sluice systems known to the person skilled in the art then being provided at the entrances and exits thereof.

The cleaning apparatus 10 first comprises a means 12 for feeding the containers into the cleaning apparatus which is designed in the form of a star wheel known per se, which carries a plurality of containers B on its outside and transfers them in a transfer area 14 to a transport apparatus 16 of the cleaning apparatus 10, which, in the view shown in FIG. 1, then transports them further in a clockwise direction. For this purpose, the transport apparatus 16 comprises a plurality of grippers 18 which, in the embodiment shown, also act as holders within the meaning of the invention and are each adapted to take over one of the containers B in the transfer zone 14 from the container feeding means 12 and to grip it from above for this purpose. By moving the grippers 18 along the transport apparatus 16 in a suitable manner, both timed and continuous operation can be enabled in the zone of the transfer area 14, though the cleaning and drying stations discussed further below each require timed operation, so that the grippers 18 may have to be buffered at suitable points during their movement.

Furthermore, by means of the transport apparatus 16, which is adapted to move the grippers 18 individually and accordingly to vary the distance between them, a start-up mode can be implemented in which, when the cleaning apparatus 10 starts up, all of the holders 18 are moved out of the area of the cleaning station 24 and drying station 26 described below.

Moreover, the cleaning apparatus 10 may be further adapted to be operable in a repeat cleaning mode, whereby, in the event of a malfunction of the cleaning station 24 and/or the drying station 26, containers B that have already been treated in the corresponding station 24, 26 are re-treated. For this purpose, appropriate sensors can be provided and operationally coupled to the transport apparatus to detect the corresponding malfunction.

In a manner analogous to the transfer zone 14, a transfer of the cleaned and dried containers B to a means 22 for discharging the containers from the cleaning apparatus 10 takes place in the area of a discharge zone 20, which is also configured as a star wheel and takes over the cleaned and dried containers B from the grippers 18. These grippers 18 then continue to run along the transport apparatus 16 until they reach the transfer area 14 again, where they can pick up containers B once more.

Between the discharge zone 20 and the transfer zone 14, the transport apparatus 16 may further implement an empty space compensation system, for which purpose an empty space detection unit 12a associated with the container B feeding means 12 is provided. In its operation, this detects if there is no container B at an input position of the feeding means 12, but rather an empty space L as shown in FIG. 1. When such an empty space L is detected, the transport apparatus 16 then holds back the next holder 18 until a container B is again fed into the transfer area 14 by the feeding means 12.

Between the container feeding means 12 and the container discharging means 22 there is, as previously mentioned, along the transport apparatus 16 firstly a cleaning station 24 and downstream of this a drying station 26, which will be explained below with reference to FIGS. 2 and 3, with a blow-off station 25, which will be explained below with reference to FIG. 7, further provided between the cleaning station 24 and the drying station 26. Here it should first be noted that both the cleaning station 24 and the drying station 26 can use the annular nozzle explained with reference to FIG. 2, but in particular the drying station 26 can also be configured differently, since at this point the risk of contamination of sensitive areas of the pharmaceutical containers B is reduced compared to the cleaning station 24, in which there is always a risk of spray and detached contamination, which on the other hand should no longer be present in the drying station 26 which generally achieves its effect by means of gas flows.

Accordingly, FIG. 2 shows a double annular nozzle 100 which can be used in the cleaning station 24 and, if applicable, also in the drying station 26. This double annular nozzle 100 is shown in FIG. 2 in an open side view and a plan view and comprises a cylindrical housing 102, which is provided on its inner wall with a first circumferential row of outlet openings 104 at a first vertical position relative to the vertical direction Z and with a corresponding second circumferential row of outlet openings 106 at a second vertical position arranged vertically above this.

As will be explained below with reference to FIG. 3, these rows of outlets 104 and 106 are supplied with a cleaning or drying medium and are oriented so that the medium ejected from them forms a cyclone or vortex around the containers to be cleaned or dried. For this purpose, the individual outlet openings are oriented in such a way that they discharge the corresponding cleaning or drying medium in a substantially identical manner inwards into the housing 102, downwards at an angle with respect to the horizontal direction X and also at an angle relative to a radial direction R, resulting in the cyclone C shown in the plan view of FIG. 2. In particular, by adapting the angle in the radial direction to the circumference of the containers B to be cleaned, a tangential contact of the cleaning or drying medium with the outside of the containers B can be achieved, which leads to improved cleaning or drying results.

Furthermore, by choosing an angle to the horizontal X in the second row of outlet openings 106 that is greater than that of the first row of outlet openings 104, for example 30°, the cleaning medium can be guided downwards in relation to the vertical direction in such a way that the occurrence of spray travelling upwards and thus into an area of a head portion of the containers B is prevented or at least greatly reduced. At the same time, the smaller angle of the first row of outlet openings 104 relative to the horizontal X leads to an improved cleaning result.

Furthermore, by also contributing to the cleaning process, while further preventing or at least reducing the formation of spray travelling vertically upwards, the second row of outlet openings 106 ensures economical operation of the apparatus, both in terms of the pressures to be applied and the amount of medium used.

In its operation, the double annular nozzle 100 can be moved in a vertical direction Z with respect to the transport apparatus 16 of FIG. 1, so that it is first moved vertically downwards into an area corresponding to a positioning of the grippers 18 and thus of the containers B to be cleaned at their intended cleaning positions above the annular nozzle 100, whereupon the annular nozzle 100 is then moved vertically upwards along the extent of the container to be cleaned until the entire area to be cleaned has been swept, the nozzle 100 then being moved back to its starting position, enabling the now cleaned container B to be transported away by means of the transport apparatus 16.

At this point it should also be noted that, although the annular nozzle 100 in FIG. 2 is shown with two rows of outlet openings 104 and 106, in a simplified embodiment of the present invention only one of the two rows 104, 106 might be provided at this point or, in further variants, additional outlet openings might also be included, for example along at least one further circumferential row.

Furthermore, while such a nozzle 100 can be individually held and supplied with cleaning or drying medium, it is possible in particular to arrange such nozzles 100 in pairs by means of the holder 110 shown in FIG. 3, which enables two such nozzles 100 to be held, operated and moved together.

In the cross-sectional plan view shown in FIG. 3, the sectional plane lies in the area of one of the two circumferential rows of outlet openings 104 and 106, so that it can be seen from this Figure how the outlet openings are supplied with cleaning or drying medium. Firstly, a supply channel for the corresponding medium is provided inside the symmetrically constructed holder 110, through which medium is introduced into the holder from outside at a suitable pressure.

In a central area between the two nozzles 100, a blind hole 114 is also provided as a special embodiment of a connection, in which the supply channel 112 divides and passes through respective bores into two circumferential annular channels 116 and 118, each of which supplies one of the two nozzles 100 with medium. This embodiment of the medium supply system consisting of the supply line 112, the blind hole 114 and the annular channels 116 and 118 allows an undercut-free flow path to be created for this purpose, in which the occurrence of vortices is prevented and thus a pressure loss of the medium is minimised. The optimised media flow also optimises the uniform and repeatable cleaning of the containers. Furthermore, the outlet openings are supplied essentially simultaneously so that they form the jets and thus the cyclone quickly and evenly.

Consequently, the double annular nozzle implemented by means of the holder 110 in FIG. 3 does not require the medium to be supplied at an elevated pressure and, in particular, can also be operated with cleaning medium in a low pressure range of, for example, 0.5 bar.

While the grippers 18 previously shown in FIG. 1, which are moved by means of the transport system 16 and at the same time carry the containers B to be cleaned, are only functionally required to be able to selectively pick up and release the containers B, three specific embodiments of such grippers are presented below on the basis of FIGS. 4a to 6, being individually suitable in particular for vials, carpules and ampoules.

Firstly, FIGS. 4a and 4b show two variants of a first embodiment 200 and 200′ respectively of a gripper configuration in a cross-sectional view, which are adapted to hold the container B1 also shown in FIGS. 4a and 4b in such a way that its head portion B1a is protected during the cleaning process. Here, particularly in FIG. 4a, the head portion B1a is subjected to an overpressure, which makes this variant particularly suitable when the cleaning station 24 is operated at high pressure.

For this purpose, the gripper 200 is made up of two half parts 202 and 204, which can be pivoted against each other, for example, in such a way that they allow selective pick-up or delivery of the container B1 in the transfer areas 14 or 20 shown in FIG. 1. The actual holding of the container B1 is achieved by means of a gripping portion 206, which on the one hand causes an engagement with the container B1 just below the head portion B1a and on the other hand includes an additional sealing lip in the area of the neck portion B1b of the container B1.

This method of holding the container B1 forms a sealed receiving space 208 around its head portion B1a, which can additionally be pressurised with a gaseous medium at an elevated pressure compared to the ambient pressure by means of a gas supply apparatus not shown here. Compressed air, but on the other hand also a suitable inert gas, could be used for this purpose.

This embodiment 200 of a gripper increases the protection of the head portion B1a and, if applicable, of a sealing cap disposed there against the penetration of cleaning medium in the cleaning station 24 shown in FIG. 1. For this purpose it relies not only on mechanical sealing by the gripping portion 206 at the sealing points, but also on the pressure difference between the interior of the receiving space 208 and the environment of the container B1. Thus, in addition to the seal, the cleaning medium is prevented from penetrating the seal, due, for example, to a capillary effect or forces acting from the outside. Consequently, applying an overpressure to the receiving chamber 208 further improves the protection of the head portion B1a of the container B1, especially with high media pressures.

In contrast, FIG. 4b shows a variant of this embodiment, designated 200′, which also comprises two half parts 202′ and 204′ and a gripping portion 206′. Here, the application of an overpressure to a receiving space for the head portion B1a of the container B1 is dispensed with and there is only spatial shielding against moisture in the gripping portion 206′ and thus of the head portion B1a of the container B1. Accordingly, this variant 200′ is particularly suitable for lower media pressures in the cleaning station 24, saving costs and effort by dispensing with the overpressure system shown in FIG. 4a, provided that the corresponding media pressure does not require corresponding additional effort.

FIG. 5, on the other hand, shows a second embodiment 300 of a gripper such as could be used in the apparatus 10 of FIG. 1. Here, the embodiment 300 is particularly suitable for gripping and cleaning a carpule B2 where only the cylindrical part B2b disposed below the head portion B2a is to be cleaned and, if applicable, dried. In this case, the head portion B2a and the inner carpule area or the lower opening B2c must be protected from the cleaning medium.

At this point it should be noted that, in a variant of embodiment 300 shown in FIG. 5, analogous to embodiment 200 of FIG. 4a, a pressurisable receiving space can also be provided in the area of the head portion B2a of the carpule B2 in order to further improve the protection of this head portion B2a from cleaning medium.

Again, the gripper 300 comprises two half-parts 302 and 304 for selectively picking up and delivering the carpule B2, which together form a gripping portion 306 for carrying the carpule B2. With the carpule B2 shown in FIG. 5 in the gripped state, the annular nozzle 100, also shown here, can now be moved to its upper position according to the double arrow shown next to it before the actual cleaning process begins. For this purpose, the sealing plunger 308 can also be moved upwards from below until it closes the bottom opening B2c of the carpule B2 and consequently prevents the ingress of cleaning medium during the subsequent cleaning process carried out by means of the annular nozzle 100. During this cleaning process, the annular nozzle 100 moves vertically downwards along the extent of the carpule B2, it being possible, once this movement is completed, to move the annular nozzle 100 vertically downwards together with the plunger 308 far enough to allow the carpule B2 to be transported away with the aid of the gripper 300 and the transport apparatus 16.

FIG. 6 now shows an embodiment of a gripper 400 which is particularly suitable for picking up ampoules B3 which are to be cleaned completely, that is to say, both in the area of their head B3a and in the area of their cylindrical body B3b and their base B3c. For this purpose, the embodiment of a gripper 400 shown in FIG. 6 again comprises, in its upper region, two half parts 402 and 404, which together form a gripping portion 406, and, as an external component, a height-displaceable support apparatus 408, which is adapted to support the ampoule B3 from below.

The corresponding cleaning process of the ampoule B3 now takes place in such a way that, after the ampoule B3 has been moved to its intended position in the area of the annular nozzle 100, the support apparatus 408 is first moved vertically upwards until the ampoule B3 is supported in the area of its base B3c, while at the same time the annular nozzle 100 is moved to an upper position.

The two half parts 402 and 404 of the gripper 400 are then opened so that the head portion B3a of the ampoule B3 is released. In the next step, the holding apparatus 408 is then moved together with the ampoule B3 to a lower position and the annular nozzle 100 begins its cleaning process in the manner described above. By transferring the ampoule B3 back to its upper position during operation of the annular nozzle 100, first the head B3a and then the cylindrical portion B3b of the ampoule are successively cleaned by the nozzle 100.

With the ampoule B3 in the upper position, the two half-parts 402 and 404 now close again and the ampoule B3 is held by the gripping portion 406 in the area of its head B3a, while the support apparatus 408 moves vertically downwards together with the annular nozzle 100 and thus moves away and cleans the remaining part of the cylinder section B3b. A nozzle 410 integrated in the support apparatus 408 can also clean the bottom of the ampoule B3 in this step. Subsequently, both the support apparatus 408 and the nozzle 100 are lowered far enough to allow further transport of the ampoule B3 by means of the transport apparatus 16.

Finally, FIG. 7 shows a possible embodiment of the blow-off station 25 from FIG. 1 in three views from the side (top left view), from the front (top right view) and from above (bottom view). This shows that two blow-off units 25a and 25b are provided, each of which uses a plurality of compressed air nozzles to create a corresponding air curtain VA and VB which are at an angle to each other and through which the gripper 18 is passed by the transport apparatus 16 in order to blow it off.

The task of the blow-off station is to blow off medium adhering to the gripper 18, in particular after cleaning the container in the cleaning station 24 with cleaning medium under high pressure. This reliably prevents a carry-over of medium to downstream system components due to wetting of the gripper 18, despite the expected increase in spray formation.

1. A cleaning apparatus for pharmaceutical containers, comprising:
means for feeding the containers into the cleaning apparatus;
means for discharging the containers from the cleaning apparatus;
a transport apparatus for transporting the containers within the cleaning apparatus;
at least one holder for holding at least one of the containers during a cleaning process, such that a longitudinal axis of each of the containers extends substantially in a vertical direction; and
at least one cleaning station for cleaning the containers, wherein each cleaning station comprises at least one substantially cylindrically formed annular nozzle configured to completely surround one of the containers during a cleaning process, wherein each cleaning station is provided on its inner side with a first row of outlet openings disposed circumferentially in a first vertical position, and wherein each cleaning station is configured to discharge a cleaning medium substantially identically inwardly and downwardly at a first angle to a horizontal axis of each of the containers and at an angle to a radial direction to form a cyclone of cleaning medium.

2. The cleaning apparatus of claim 1, wherein the annular nozzle further comprises a second row of outlet openings at a second vertical position above the first position, each of the outlet openings of the second row also being configured to discharge the cleaning medium substantially identically inwardly and downwardly at a second angle to the horizontal axis and at a second angle to the radial direction so as to form a second cyclone of cleaning medium, the second angle being greater than the first angle.

3. The cleaning apparatus of claim 2, wherein the outlet openings of the first row of outlet openings are each adapted to discharge the cleaning medium at the first angle to a side of the container with respect to the radial direction and the outlet openings of the second row of outlet openings are each adapted to discharge the cleaning medium at the second angle to the same side with respect to the radial direction to form co-rotating cyclones.

4. The cleaning apparatus of claim 1, further comprising:
at least one pair of annular nozzles supported in a substantially symmetrical manner on a common holder; and
a supply channel provided within the common holder for delivering cleaning medium to the at least one pair of annular nozzles.

5. The cleaning apparatus of claim 4, wherein each outlet opening of one or more of the first row of outlet openings or a second row of outlet openings is assigned an annular channel running around the at least one pair of annular nozzles for transport of the cleaning medium, via which the each such outlet opening is supplied, a transition between the supply channel and each of the annular channels being realized via a connection and bores running obliquely with respect to the direction in which the common holder extends.

6. The cleaning apparatus of claim 1, further comprising at least one flat seal for sealing the at least one annular nozzle.

7. The cleaning apparatus of claim 1, further comprising a drying station disposed downstream of the cleaning station with respect to the transport apparatus.

8. The cleaning apparatus of claim 7, wherein one or more of the at least one annular nozzle or the at least one annular drying unit are displaceable in the vertical direction in a manner coordinated with the transport apparatus.

9. The cleaning apparatus of claim 1, wherein the at least one holder is configured as a gripper associated with the transport apparatus, wherein the at least one holder is configured to hold the at least one container at an upper end of the at least one container.

10. The cleaning apparatus of claim 9, wherein the at least one holder is configured to grip one or more of vials, ampoules, or carpules.

11. The cleaning apparatus of claim 9, wherein the at least one holder is configured to grip a container of the containers in a neck portion of the container with a gripping portion and wherein the at least one holder comprises a receiving space for receiving a head portion of the container in a gripped state.

12. The cleaning apparatus of claim 11, wherein the gripping portion is configured to grip the container in a sealed manner such that the receiving space is sealed from an environment with the container in the gripped state, the cleaning apparatus further comprising means for applying a gaseous medium at an elevated pressure to the receiving space.

13. The cleaning apparatus of claim 4, further comprising at least one height-displaceable support apparatus configured to support a container of the containers below one of the at least one pair of annular nozzles or below at least one annular drying unit configured to completely surround one of the containers during a drying process.

14. The cleaning apparatus of claim 1, further comprising a blow-off station disposed downstream of the cleaning station with respect to the transport apparatus and between the cleaning station and a drying station, wherein the blow-off station is configured to blow off the holders associated with the transport apparatus by means of at least one air curtain.

15. The cleaning apparatus of claim 1, wherein the transport apparatus is further configured to implement an empty space compensation system, the cleaning apparatus further comprising an empty space detection unit associated with the means for feeding the containers configured to detect that no container is present at an input position of the means for feeding the containers but rather an empty space, wherein the transport apparatus is configured to hold back a next holder in an event of a detection of empty space in a transfer area between the means for feeding the containers and the transport apparatus until a container is again fed into the transfer area by the means for feeding the containers.

16. The cleaning apparatus of claim 7, wherein the transport apparatus is further configured to be operable in a start-up mode in which all of the holders are moved out of an area of the cleaning station and of the drying station when the cleaning apparatus is started up.

17. The cleaning apparatus of claim 7, wherein the cleaning apparatus is further configured to be operable in a repeat cleaning mode in which, in an event of a malfunction of one or more of the cleaning station or the drying station, containers that have already been treated in the cleaning station or the drying station are re-treated.

18. The cleaning apparatus of claim 2, wherein the second angle is thirty degrees (30°).

19. The cleaning apparatus of claim 5, wherein the connection comprises a blind hole.

20. The cleaning apparatus of claim 7, wherein the drying station comprises at least one annular drying unit configured to completely surround one of the containers during a drying process.
